(19) United States
(12) Patent Application Publication
(10) Pub. No.: US 2003/0185163 A1
(43) Pub. Date: Oct. 2, 2003

(54) System and method for wireless cable data transmission

(76) Inventors: James G. Bertonis, Los Gatos, CA (US); Robert Buaas, Huntington Beach, CA (US); Tomany Szilagyi, Felton, CA (US); David B. Leeson, Los Gatos, CA (US)

Correspondence Address: PENNIE AND EDMONDS, 1155 AVENUE OF THE AMERICAS, NEW YORK, NY, 100362711

(21) Appl. No.: 10/109,354

(22) Filed: Mar. 27, 2002

(51) Int. Cl. H04J 1/10

(52) U.S. Cl. 370/315

(57) ABSTRACT

A first repeater comprising an input node for receiving downstream signals and re-transmitting the data sent over these signals on a non-license frequency. The first repeater further comprising another input node for receiving upstream signals sent over another non-license frequency, and re-transmitting the data over the upstream channel. In another embodiment of the system a second repeater is wirelessly coupled with the first repeater such that the second repeater receives the downstream data over a first non-license frequency and re-transmits the data over the first non-license frequency. The second repeater is further capable of receiving the upstream data over a second non-license frequency and re-transmitting the data over the second non-license frequency.

The present invention relates generally to data transmission over wireless channels, and more particularly to the distribution of communication information using wireless cable.

### BACKGROUND OF THE INVENTION

At present, most households with Internet access use telephone modems and telephone lines to establish communication with an Internet service provider (ISP) and access the Internet. The data rate over telephone lines is limited due to limited bandwidth. High speed wireless Internet is available using Local Multipoint Distribution Service (LMDS), but this approach requires a license from the Federal Communications Commission (FCC) and is relatively expensive. Furthermore, the service is not generally available. Therefore, providing Internet access over cable communication systems has become an attractive alternative: greater bandwidth is available to provide high data rates, and many households are already connected to a local cable provider.

However, providing full-duplex Internet access via cable requires both a forward channel from the cable provider to the subscribing household (also known as the downstream direction), and a reverse channel from the subscribing household to the cable provider (also known as the upstream direction). Internet data such as web page content, received email, or other transmissions are transmitted downstream to the subscriber, and the subscriber transmits data such as requests for web page access or sent email upstream to the service provider. The subscribing household is equipped with a cable modem with a computer or with a set-top box, which receives and demodulates the downstream data, and modulates and transmits the upstream data.

Although Internet access over cable provides increased speed over telephone access, it is not ideal. Cable systems were originally developed to send information only in the downstream direction—to send television programming from the cable service provider to the subscribing household. Although some cable systems have been modified for upstream transmission, many have not, and must use an alternative such as telephone lines for upstream transmission. Furthermore, some households do not have access to cable. Finally, since local cable systems are by nature monopolistic, competition among Internet service providers (ISPs) providing service over cable is limited.

Therefore, wireless Internet access is an attractive alternative to access over cable. To this end, ISPs have attempted to provide wireless access at data rates comparable to the data rates available over cable. Multi-channel multipoint distribution service (MMDS) was originally licensed as a one-way service providing wireless video programming sometimes referred to as “wireless cable.” The MMDS channels were conceived as an alternative means to cable for providing television service in remote areas. A limited number of wireless channels were designated for MMDS and auctioned off by the FCC. The wireless cable industry, however, largely failed to compete with wired- and satellite-based video programming providers. As a result, the FCC revised its rules to permit MMDS to be used for bi-directional services, allowing the frequencies to be used for high-speed Internet access. Today, MMDS is also used to deliver Internet traffic and a number of standards are being defined to support this bi-directional data delivery. Such standards include broadband wireless Internet forum (BWIF) and wireless digital subscriber line (DSL). The signals over wireless cable are processed to mimic cable signals, so that, unlike LMDS, standard cable modems may be used. The processing is performed using additional equipment, usually in an outdoor unit (ODU) at the subscriber location.

Some cable modems are compliant with Data Over Cable Service Interface Specifications (DOCSIS), which are interface specifications for standard, interoperable, data-over-cable network products. ISPs utilizing MMDS may also be compatible with DOCSIS. However, current MMDS networks are not entirely satisfactory. MMDS networks are characterized by the limited number of channels available in the low RF bands typically used for the upstreams. This constraint reduces the effective number of channels in a single MMDS system. No more than two 6 MHZ channels may be allocated to the upstream direction, which is a significant limitation.

Fortunately, in 1997, the FCC set aside 300 MHz of spectrum in the 5 GHz band for U-NII service. Three bands are defined in this spectrum: 5.15 to 5.25 GHz (U-NII band 1) and 5.25 to 5.35 GHz (U-NII band 2), which are designated for wireless LAN and other short-range use; and 5.725 to 5.825 GHz (U-NII band 3) for wide-area networking that reaches a greater distance with higher power. The U-NII bands are designated for wideband, high-data-rate digital communications. They are also license-free: no license is required to operate on the U-NII bands.

Devices operating in the U-NII bands face several interference problems. Both the lower edge of the 5.15-5.25 GHz band and the upper edge of the 5.25-5.35 GHz band are restricted bands (under Part 15.205). Thus, in these bands the spurious emissions of the transmitters must meet the radiated limits specified in Part 15.209 of 500 μV/m at 3 m distance. Devices operating at the lower frequency range of 5.15-5.25 GHz share this band with the digital broadcast satellite authorized to operate in the 5.090-5.250 GHz band. In addition, the 5.725-5.825 GHz band is shared with Part 15.247 spread-spectrum devices and Part 15.245 perimeter sensor devices, as well as with Industrial Scientific Medical (“ISM”)-type devices.

The ISM bands, also license-free, are centered on the frequencies 915 MHz, 2.4 GHz, 5.8 GHz, and 24 GHz. The ISM bands have respective bandwidths of 26 MHz, 83.5 MHz (spread spectrum), 150 MHz (spread spectrum), and 250 MHz.

The use of these license-free channels has generally been unattractive for wireless cable. License-free FCC channels typically require the use of spread spectrum. However, since there is interference between transmitted and received signals and since DOCSIS cannot tolerate frequency hopping and interference, a DOCSIS-compliant spread spectrum wireless system has not been developed prior to this invention.

There are two common approaches to spread spectrum transmitting. One approach to spread spectrum is frequency hopping, in which the center frequency of signals change in a pseudo-random fashion, at a rate which is less than the bit rate. Frequency hopping cannot be used for downstream transmission because continuous transmission is required in the downstream direction. A second approach to spread spectrum is direct sequence, in which signals are phase-modulated very rapidly, relative to the bit rate, in a pseudo-random fashion.

However, the complex modulation format used for downstream communications makes the use of direct sequence signals complicated and expensive. In addition, commonly employed methods for producing direct sequence signals would occupy a substantial portion of the available bandwidth without permitting the use of code division multiple access (CDMA), and would make the receiver vulnerable to narrowband interference.

CDMA is a multiple-access scheme based on spread-spectrum communication techniques. It spreads message signals to a relatively wide bandwidth by using a unique code that reduces interference, enhances system processing, and differentiates users.

In a typical spread-spectrum communication system, data signals are first modulated by traditional amplitude, frequency, or phase techniques. Pseudo-random noise (PN) signals are then applied to spread the modulated waveform over a relatively wide bandwidth. The PN signals can amplitude modulate the data signal waveforms to generate direct-sequence spreading, or they can shift the carrier frequency of the data signals to produce frequency-hopped spreading. PN sequences are typically used to spread the bandwidth of the modulated signals to the larger transmission bandwidth and distinguish between the different user signals by utilizing the same transmission bandwidth in the multiple access scheme.

Direct-sequence spread-spectrum signals are generated by multiplying the message signals d(t) by pseudorandom noise signals pn(t): g(t)=pn(t)d(t). The technique is described in CDMA Mobile Radio Design by John B. Groe and Lawrence E. Larson, incorporated herein by reference.

In addition to the problems associated with spread spectrum transmission, FCC restrictions on power level, modulation, and coding impose severe restraints. FCC regulations for radio frequency devices are described in 47 CFR, Ch. 1, Part 15, incorporated herein by reference for purposes of indicating the background of the invention and illustrating the state of the art. 47 CFR, Ch. 1, Sec. 18.101-18.311 sets out regulations for ISM devices and technical standards and is incorporated herein by reference for the same purposes.

Reference is now made to FIG. 1 where an exemplary MMDS network 100 for transmitting Internet traffic data is shown. Downstream Internet traffic data arriving from Internet 110 sources, is modulated onto microwave signals using wireless access terminal 120. These signals are transmitted as wireless microwave signals by means of antenna 130 located on top of a tower 135 or another tall structure. A microwave antenna 140, located at the subscriber's location 145, receives signals that are then down-converted and passed through a conventional coaxial cable to wireless modem 150. Wireless modem 150 demodulates the received signals, converts them to a data stream and transfers the received data to a user terminal, a router, a switch, or other means of data handling which can provide the received data to a user.

Similarly, Internet traffic is transmitted upstream from a user terminal 160 to wireless modem 150. Upstream data is converted by wireless modem 150 to microwave signals with the data modulated for the transmission and is transmitted by antenna 140 to antenna 130. Wireless access terminal 120 demodulates the data and sends it over the Internet 110 to its desired destination.

Generally, the transmission of wireless frequencies requires clear line-of-sight (LOS) between the transmitting and the receiving antennas. Buildings, hills, mountains, dense undergrowth and topography can cause signal interference, which can block signals. Certain LOS constraints can be reduced by increasing transmission power and using engineering techniques such as pre-amplifiers and signal repeaters.

One solution to the blockage problem used for MMDS television broadcast, has been to provide repeaters. A repeater receives the primary transmission from antenna 120 on the tower side of the obstruction, amplifies signals if necessary, and retransmits signals into the area of blockage. Such repeaters do not support two-way communications over the MMDS spectrum, therefore, they cannot be used for transferring Internet data, i.e., upstream and downstream data simultaneously. Therefore it would be advantageous to provide a two-way communication repeater that will solve the blockage problem, for Internet data transmission, and secondly provide additional upstream bandwidth for the MMDS system.

### SUMMARY OF THE INVENTION

In an embodiment, the present invention is a repeater comprising a first input node for receiving first wireless cable signals, including a first signal, on a first one or more frequency sub-bands, first circuitry for adjusting the first signal to a second signal, a first output node for transmitting upstream signals spread spectrum, including the second signal, on a second one or more frequency sub-bands, where one of the second one or more frequency sub-bands is a non-license band, a second input node for receiving second wireless cable signals, including a third signal, on a third one or more frequency sub-bands, second circuitry for adjusting the third signal to a fourth signal, a second output node for transmitting downstream signals, including the fourth signal, on a fourth one or more frequency sub-bands, where one of the fourth one or more frequency sub-bands is a non-license band. Downstream is never spread spectrum.

### BRIEF DESCRIPTION OF THE DRAWINGS

Additional objects and features of the invention will be more readily apparent from the following detailed description and appended claims when taken in conjunction with the drawings, in which:

FIG. 1 illustrates a basic MMDS communication scheme for delivering two-way data communication.

FIG. 2A-B illustrates a diagram of a MMDS coverage area with and without repeaters.

FIG. 3 illustrates a basic diagram of a wireless repeater in accordance with the disclosed invention.

FIG. 4 illustrates a schematic block diagram of a transceiver in accordance with the disclosed invention.

FIG. 5 illustrates a schematic block diagram of a MMDS front-end in accordance with the disclosed invention.

FIG. 6 illustrates a schematic block diagram of a modified MMDS front-end enabling fast upstream transmission.

FIG. 7 illustrates a diagram of the use of a repeater-to-repeater transmission in accordance with the disclosed invention.

FIG. 8 illustrates a block diagram of a dual conversion repeater in accordance with an embodiment of the present invention.

FIG. 9 illustrates a block diagram of a repeater used for downstream transmission in accordance with an embodiment of the present invention.

FIG. 10 illustrates a block diagram of a repeater used for upstream transmission in accordance with an embodiment of the present invention.

FIG. 11 illustrates a block diagram of a receiver at the hub in an embodiment of the present invention.

FIG. 12 illustrates a block diagram of a point-to-point repeater in an embodiment of the present invention.

FIG. 13 illustrates a block diagram of a repeater in an embodiment of the present invention.

FIG. 14 illustrates bandwidth filtering in accordance with an embodiment of the present invention.

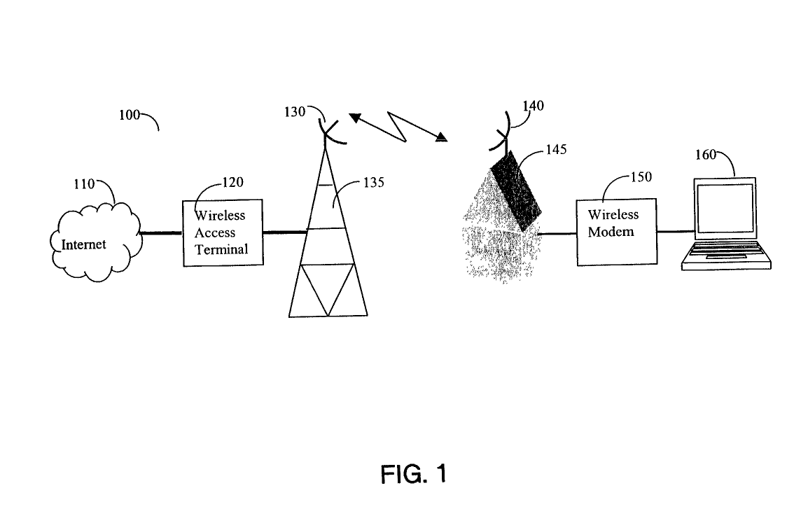

### DESCRIPTION OF THE PREFERRED EMBODIMENTS

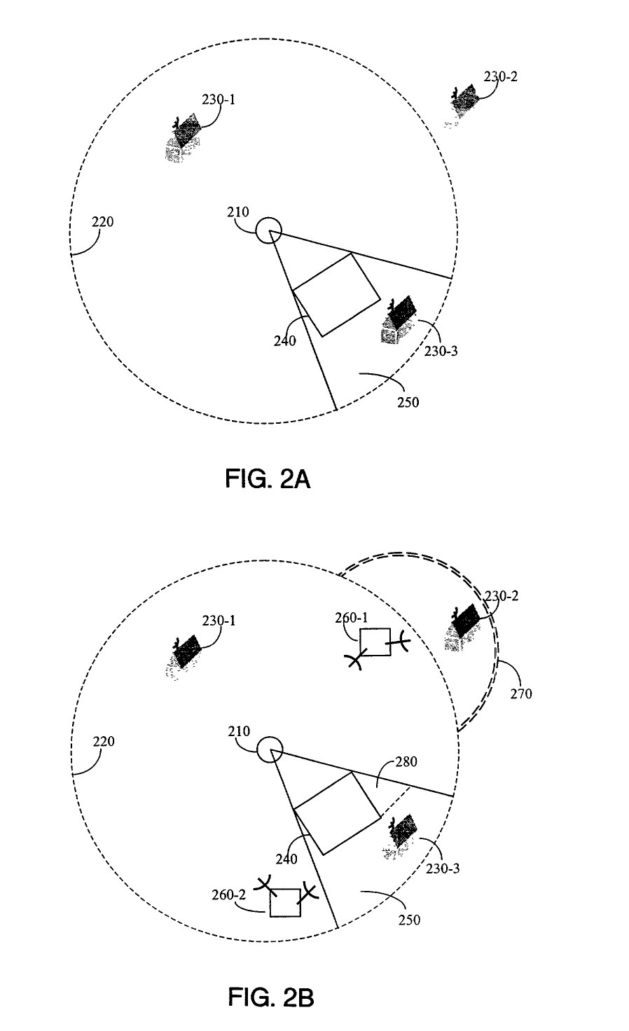

Reference is now made to FIG. 2A which depicts a basic diagram of a coverage area of a multi-channel multipoint distribution service (MMDS) system. Illustratively, the antenna is operated by an Internet service provider (ISP) to provide Internet service. An MMDS antenna 210 transmits over a limited area schematically shown as radius 220. A subscriber 230-1 is capable of receiving this transmission and potentially communicating bi-directionally where there is full line of sight (LOS) between the location of subscriber 230-1 and antenna 210. Another subscriber, subscriber 230-2, is beyond transmission radius 220 of antenna 210 and therefore is unable to receive the Internet service provided by the ISP operating antenna 210. Yet another subscriber, subscriber 230-3, is unable to receive the ISP service due to an obstacle 240 that prevents the direct LOS between antenna 210 and subscriber 230-3. In fact, all the area 250 behind obstacle 240 is shadowed from antenna 210 and therefore potential subscribers are unable to receive the ISP service in that area.

Reference is now made to FIG. 2B where a solution is shown for the problems of subscribers 230-2 and 230-3 in accordance with an embodiment of the invention. By providing a repeater 260-1 capable of communicating with antenna 210 and relaying data to and from subscriber 230-2, repeater 260-1 expands the coverage of antenna 210 to the area bounded by border 270. This includes subscriber 230-2 and hence solves his problem. Another repeater, repeater 260-2, is capable of communicating with both antenna 210 and subscriber 230-3. It should be noted, however, that repeater 260-2 may not solve the problem of area 280 that is shadowed from both antenna 210 and repeater 260-2, as well as being out of range of repeater 260-1. The solution for such an area shall be explained in more detailed below. It should be further noted that repeaters 260-1 and 260-2 do not communicate with subscribers 230-2 and 230-3 with an MMDS system. The reason for this is that MMDS requires an FCC license for broadcasting; and it is not practical or commercially viable to add additional MMDS antennas within the licensed area to solve the problems illustrated in FIG. 2A. It should be noted that subscribers 230-2 and 230-3 use antennas and reception equipment capable of handling the frequencies sent and received by repeaters 260.

The system of FIG. 2B uses widely-separated frequency channels for upstream and downstream transmission. Compliance with the FCC requirements is provided through an upstream modulation scheme that controls transmission power levels and with the use of spread spectrum. Furthermore, the upstream and downstream modulation may be constrained to meet the requirements for a standard cable modem, including a cable modem meeting the data over cable service interface specification (DOCSIS) standard. The use of wireless cable rather than standard cable is transparent to the user.

If a repeater is used in the system, the subscriber transmits on a first upstream channel. If a repeater is not used, the subscriber transmits on a second upstream channel.

For upstream transmission, the upstream channel between the subscriber 230 and the repeater 260 is preferably about centered on 2.4 GHz or 5.3 GHz. This channel may comprise one or more frequency sub-bands; it need not correspond to a single channel of, for example, MMDS. The channel is preferably a license-free channel—a range of transmission frequencies for which the FCC does not require users to purchase a license.

For upstream transmission, signals, consisting of modulated data, are generated by a cable modem associated with a subscriber 230, in response to a request from a user, for example to send email or to download a particular web page. The signals are located within the 5-42 MHz frequency band assigned by most cable operators for upstream data transmission, referred to as the “upstream frequency band.” The signals do not occupy the entire 37 MHZ bandwidth, but are contained within a 200 KHz-3.2 MHZ channel within the upstream frequency band.

Upconversion in the subscriber's out door unit (ODU) is provided by an upstream frequency translator. The frequency translator upconverts the entire upstream band, 5-42 MHZ, output by the cable modem to a 37 MHz sub-band within a wireless band. The wireless band is a range of frequencies, such as 2.4-2.4835 GHz or 5.25-5.35 GHz, suitable for wireless transmission. The upconverted signals—the “wireless upstream signals”—are thus located in a portion of each upconverted 37 MHz sub-band. For example, if the upstream signals originally occupied the frequencies 30-32 MHz, and the band 5-42 MHz is upconverted to 2.4 GHz-2.437 GHz, the wireless upstream signals will, for example, be located at 2.430 GHz-2.432 GHz. The wireless upstream signals are then provided to an antenna for wireless transmission.

The frequency translator may upconvert the upstream band to more than one 37 MHz sub-band within the wireless band: for example, in the band 2.430-2.4835 GHz, the upstream band could be upconverted to both the sub-band 2.4-2.437 GHz and the sub-band 2.4435-2.4831 GHz. The subscriber ODU would then produce the wireless upstream signals at multiple sub-bands for transmission. The headend could then select for processing the sub-band with the least interference, or could combine sub-bands to increase the signal-to-noise ratio.

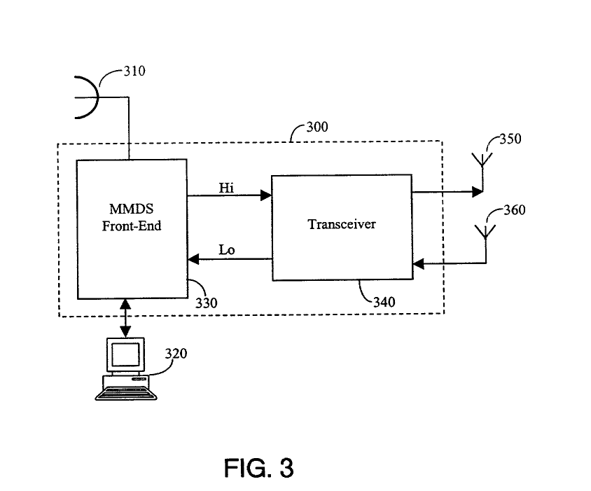

A repeater 260 receives the upconverted signals on a first upstream channel. The repeater adjusts the signals received from the subscriber 230 as described in more detail with reference to FIGS. 3-6.

Repeater 260 then transmits the adjusted signals on a second upstream channel. Typically, the wireless upstream signals have a frequency drift that is constrained to within a maximum value. The system may have a high-stability frequency reference to constrain frequency drift. Like the first upstream channel, the second upstream channel may comprise one or more frequency sub-bands. In some cases, the use of different sub-bands for reception and transmission prevents interference between the signals. The second upstream channel is preferably centered on 915 MHz, 2.4 GHz, or 5.7 GHz. In one embodiment, this is a simplex path, spread spectrum signal with synchronized orthogonal PN codes such that each repeater 260 will overlap the same entire frequency band, for example, the 902-928 MHz band. Fortuitously, this turns out to be exactly the bandwidth required to send out a 32 MHz channel using FCC 15.247 direct sequence (32 MHz, but edges can be scalloped to 26 MHz). Since receiving antennas can be highly directional and pointed at each repeater, there is no problem with jamming.

In another embodiment, the upstream MMDS channel is used. In this embodiment, repeater 260 aggregates subscriber upstream signals and puts the aggregated upstream signals back onto the MMDS upstream. The upstream channel is typically divided into a number of time slots. In this embodiment, DOCSIS preferably controls time slots such that the repeater is transparent. In an alternate embodiment, the aggregated upstream signals may be sent over a point-to-point 5.7/5.8 GHz UII band system. The FCC allows up to +17 dB of additional antenna gain on this band for point-to-point only.

The antenna 210 receives upstream signals transmitted on the second upstream channel.

In another embodiment, upstream signals are relayed by multiple repeaters to the operating antenna 210. For example, a first repeater may receive signals from a subscriber and transmit signals to a second repeater. The second repeater relays the signals to the operating antenna 210. In this embodiment, the second repeater preferably receives and transmits at upstream at the same frequency; the same is preferably true at downstream.

For downstream transmission, in one embodiment the operating antenna 210 transmits downstream signals on a first downstream channel. The repeater 260 then transmits the downstream signals on a second downstream channel to a subscriber 230. The center frequency of the first downstream channel and the second downstream channel 114 is preferably 5.8 GHz. The center frequency of the first downstream channel could be other frequencies, for example 5.3 GHz. In an alternate embodiment, the operating antenna 210 transmits signals directly to the subscriber 230-1 on a third downstream channel. The center frequency of the third downstream channel is preferably 2.6 GHz. Appropriate receivers are used at the subscriber 230 depending on whether signals are received directly from the antenna 210 or from the repeater 260.

A repeater 300 in accordance with an embodiment of the present invention is illustrated in FIG. 3. The repeater 300 is comprised of two basic units, MMDS front-end 330 and a transceiver 340. It is the function of MMDS front-end 330 to handle MMDS signals, create the downstream intermediate frequencies (IF) signals used by transceiver 340 and receive the upstream IF provided by transceiver 340. It is further a task of MMDS front-end 330 to provide local upstream and downstream communication at the repeater 300 location. Transceiver 340 sends the downstream data to a subscriber using frequencies that do not require an FCC license. Transceiver 340 receives the upstream data from a subscriber using another frequency that does not require an FCC license. The signals are then transferred to an upstream IF and provided to MMDS front-end 330. Typical frequencies for IF are 225 MHz through 411 MHz for downstream data and 12 MHz to 48 MHz for upstream data. An antenna 310 suitable for MMDS transmission is connected to MMDS front-end 330. Antennas 350 and 360 are connected to transceiver 340 to transmit and receive signals to and from subscribers. A terminal 320 may be optionally connected to MMDS front-end 330 to allow for repeater maintenance and other functions local to the repeater site.

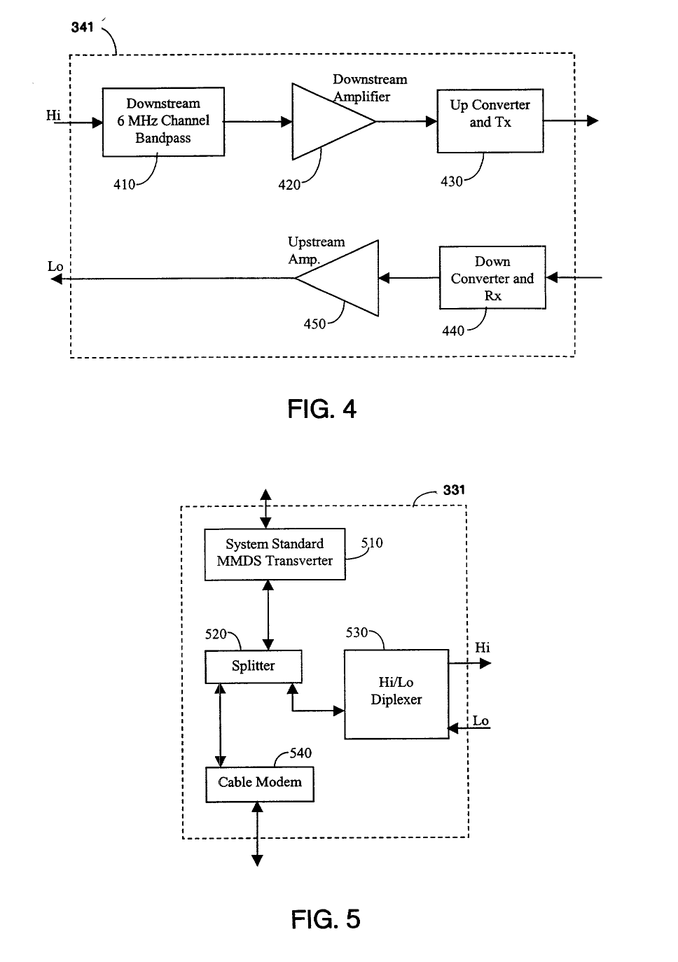

Reference is now made to FIG. 4 where a schematic block diagram of a transceiver 341 is shown. Transceiver 340 comprises a downstream channel bandpass (DCB) filter 410, an amplifier 420, and an upconverter and transmitter (UCTX) 430. It also comprises a downconverter and receiver (DCRX) 440 and an amplifier 450. The DCB filter 410 limits the bandwidth passed from the MMDS spectrum to a single downstream channel, typically a six MHz channel. Ideally, the downstream IF is chosen such that it aligns with a standard cable television (CATV) channel. This allows for the use of standard filters that are readily available in the market. The DCB filter 410 is connected to downstream amplifier 420, which is targeted to compensate for small signal variations resulting from temperature changes, moisture changes, or other environmental changes. An automatic gain control (AGC) unit should be used, avoiding a large dynamic range, to prevent excessive amplification of noise. The problem arising from excessive gain is that the modem may falsely detect signals and cause link disconnects. Downstream amplifier 420 is connected to UCTX 430 that converts the IF to the transmission frequency used to send data to subscriber. Typically a frequency of 5.8 GHz is used for this purpose, which is a frequency not requiring an FCC license. Data is received by transceiver 341 by means of DCRX 440. DCRX 440 converts the frequency received, typically 5.3 GHz which is a frequency not requiring FCC licenses, to the IF used in transceiver 340. DCRX 440 is connected to upstream amplifier 450. Upstream amplifier 450 is an adjustable amplifier to allow settings such that the upstream IF signals at the repeater from the most distant subscriber provide an equivalent signal level to the upstream IF input of the MMDS transverter.

Reference is now made to FIG. 5 where details of one embodiment of the MMDS front end 330 are shown. Front end 331 comprises a standard MMDS transverter 510, a splitter 520 (optional), a hi/lo diplexor 530, and a cable modem 540. MMDS front-end 331 uses a standard MMDS transverter 510 to connect to an MMDS antenna and send downstream 2.6 GHz signals and upstream 2.2 GHz signals. It should be noted though, that the upstream channel of a 2.2 GHz MMDS-based system available to subscribers is usually limited and significantly smaller in bandwidth. An optional splitter 520 may be used when local connectivity is necessary. In this case splitter 520 may be connected to cable modem 540 that is then connected to terminal 320. Hi/Lo Diplexer 530 is connected to transverter 510 directly (not shown), or optionally through splitter 520. Diplexer 510 separates the upstream IF from the downstream IF which are normally transmitted over a single coaxial cable. Devices are commercially available for these purposes. A person skilled in the art could modify this configuration where necessary to provide additional upstream bandwidth.

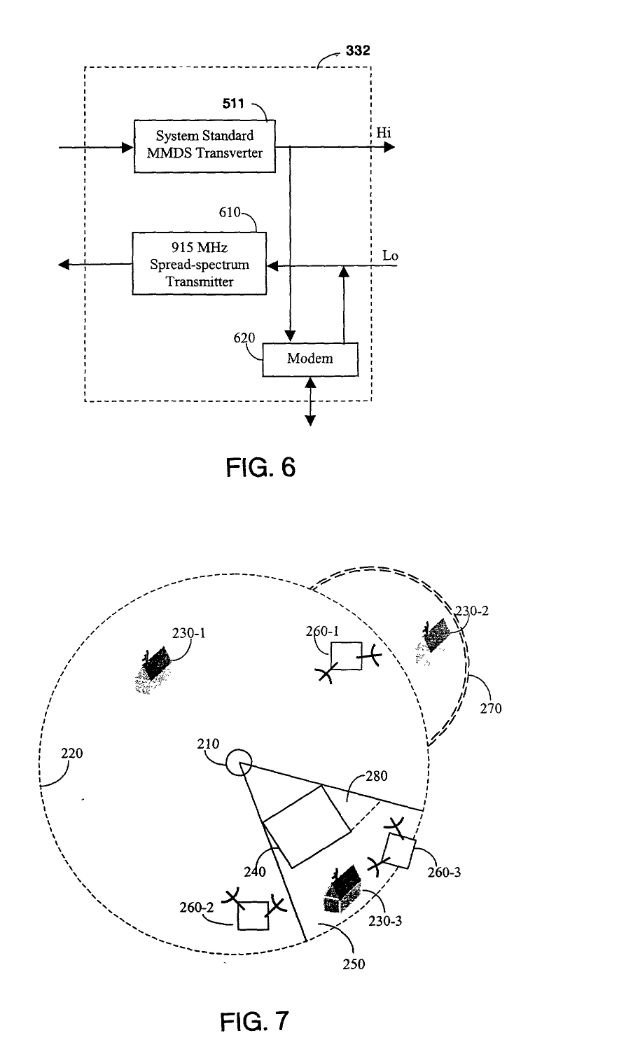

Reference is now made to FIG. 6, which shows a block diagram of a modified front-end 332 having additional upstream bandwidth. In this modified MMDS front-end, upstream signals are sent using a preferably 915 MHz spread spectrum transmitter 610. Upstream data is sent through this unit to its antenna and is capable of providing a higher upstream bandwidth for data sent from a subscriber through the repeater to an ISP. An appropriate modem 620 is capable of handling such data from the separate upstream and downstream data streams for local use at the repeater site.

A person skilled in the art could use a different type of front end 330 to accomplish repeater-to-repeater connectivity. The modified front end resends the upstream data on the same frequency it received the data, for example 5.3 GHz. Similarly it resends the downstream data at the same frequency it received the data, for example 5.8 GHz.

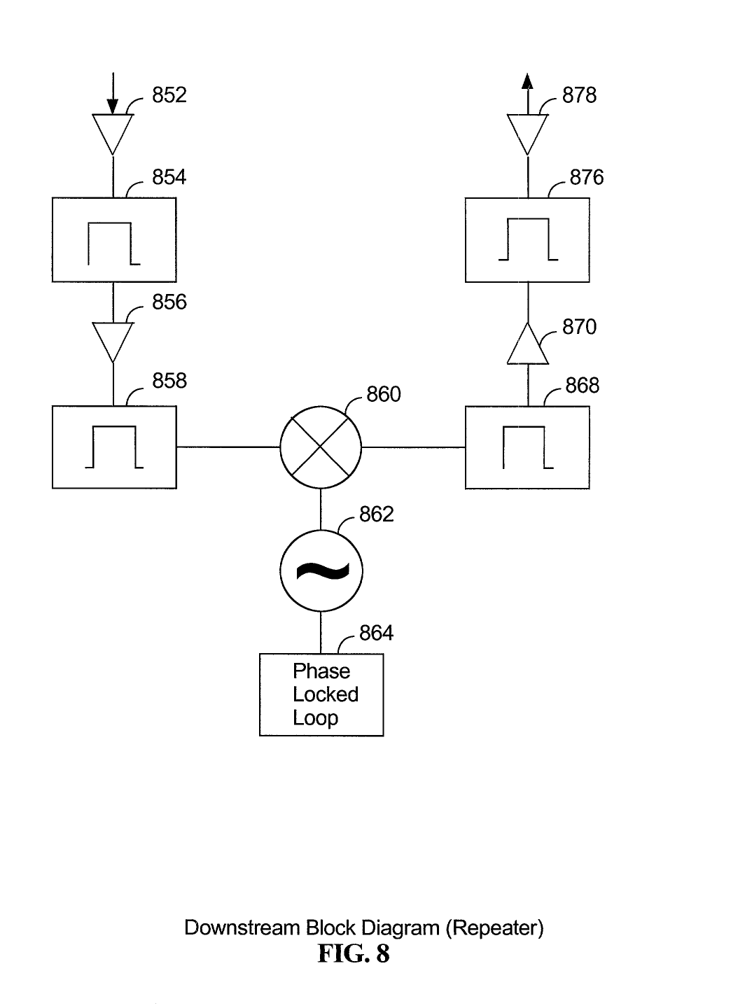

Reference is now made to FIG. 7 where a repeater 260-3 is added. Repeater 260-3 front-end is capable of communication with repeater 260-2. This means that repeater 260-3 is capable of resending upstream data at the frequency it received the data, for example 5.3 GHz, and similarly resending the downstream data at the frequency it received it, for example 5.8 GHz. At the location it is positioned it can now provide coverage to the previously shadowed area 280. Downstream communication to subscribers located in area 280 is provided from antenna 210 through repeater 260-2 and 260-3. Antenna 210 communicates with repeater 260-2 using MMDS frequency bands, typically centered on 2.6 GHz downstream and 2.2 GHz upstream. Repeaters 260-2 and 260-3 typically transmit in frequencies that do not require licenses, such as FCC licenses, for example 5.8 GHz downstream and 5.3 GHz upstream.

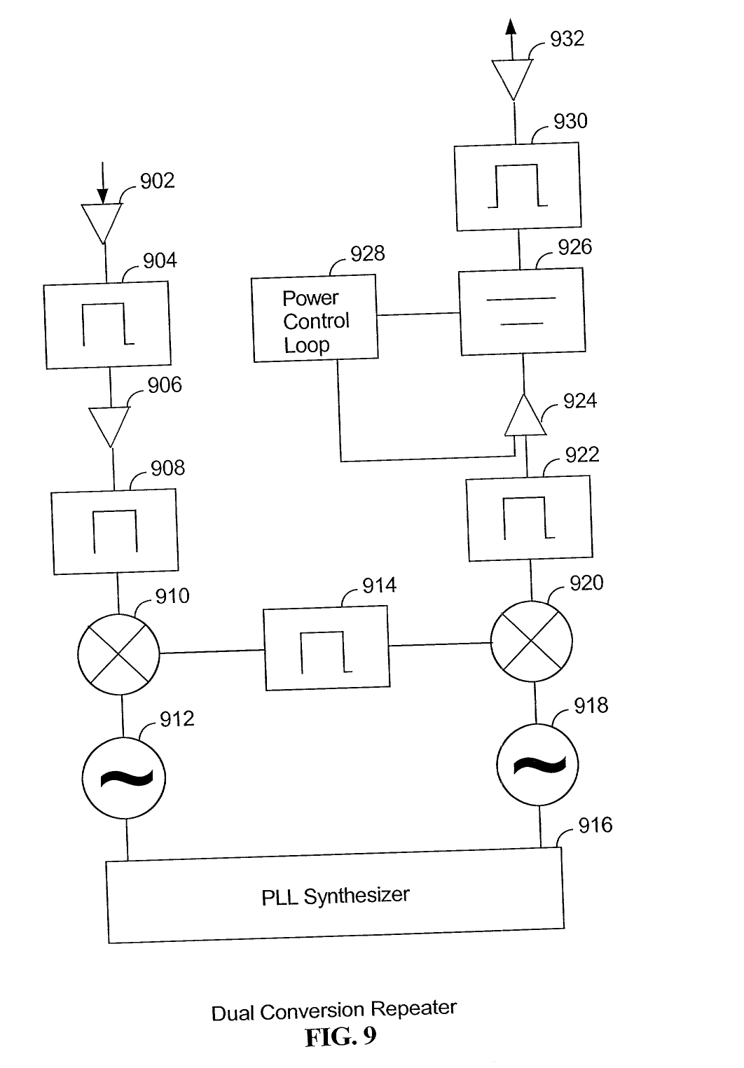

FIG. 8 illustrates a repeater in accordance with an embodiment of the invention. In FIG. 8, signals are received by receiver 852. Received signals are filtered by band pass filter (BPF) 854. The signals are amplified by low noise amplifier (LNA) 856. The signals are then filtered by image BPF 858. Image BPF 858 attenuates incoming signals that are at the image frequency of the first local oscillator (LO) 862. The phase-locked loop (PLL) 864 controls the first LO 862 in generating first LO signals in the intermediate frequency (IF) band. The IF is preferably between 225 MHz and 411 MHz. The filtered signal is mixed at mixer 860 with the first LO signals. Since the carrier frequency of the signal received by receiver 852 is governed by strict FCC requirements and possibly even international governing agencies, precise signals are required from the LO 862. The mixer 860 performs frequency translation; it is functionally equivalent to an analog multiplier that linearly multiplies two input signals, in this case, the signal frequency and the lower frequency, to produce a mixed signal described by:

s(t)=A cos(2πf₁t)×cos(2πf₂t),

where

f₁ is the input signal to be shifted, and

f₂ is the local oscillator signal.

The mixed signals are then filtered at BPF 868 and amplified by power amplifier (PA) 870. Then, the signals are filtered by BPF 876. Finally, the signals are transmitted at transmitter 878.

FIG. 9 illustrates a dual conversion repeater in accordance with an embodiment of the present invention. In FIG. 9, signals are received by receiver 902. Received signals are filtered by BPF 904, amplified by LNA 906, and filtered again by image BPF 908. The PLL synthesizer 916 controls the first LO 912 and the second LO 918 in generating first LO signals and second LO signals, respectively. The filtered signals are mixed at mixer 910 with the first LO signals. The mixed signals are filtered by intermediate frequency (IF) surface acoustic wave (SAW) BPF 914. The IF SAW BPF 914 preferably has an ideal (flat) bandpass response with a bandwidth that is at least equal to the bandwidth of the channel on which signals are received by receiver 902. The filtered signals are then mixed at mixer 920 with the second LO signals. The mixed signals are filtered at BPF 922 and amplified by PA 924. At level detector 926 the signals enter a power control loop. The power control loop clamp 928 limits the signal to a minimum and maximum that is within the FCC or other governing body limitation for transmitted power level. Then, the signals are filtered by BPF 930. Finally, the signals are transmitted at transmitter 932.

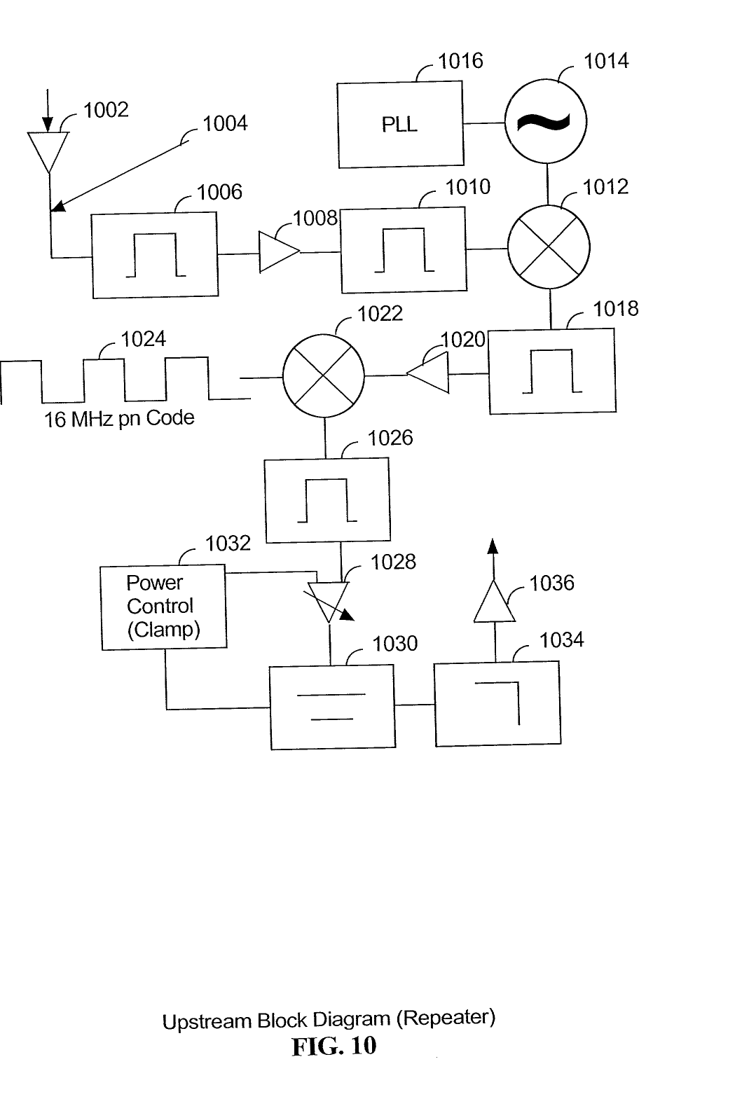

FIG. 10 illustrates an upstream repeater path. In FIG. 10, signals are received by receiver 1002. A test signal 1004 is inserted for clock alignment and periodic performance testing. The received signal are filtered by BPF 1006, amplified by LNA 1008, and filtered again by BPF 1010. The PLL 1016 controls LO 1014 in generating first LO signals. The filtered signals are mixed at mixer 1012 with the first LO signals. The mixed signals are filtered by BPF 1018. The filtered signals are amplified by PA 1020. The amplified signals are mixed by mixer 422 with a 16 MHz pseudo-random noise (PN) code 1024.

A preferred PN sequence is one wherein the relative frequencies of 0 and 1 are each ½; the run lengths (of 0s or 1s) are: ½ of all run lengths are 1, ¼ are of length 2, ⅛ are of length 3, and so on; and if a PN sequence is shifted by any nonzero number of elements, the resulting sequence has an equal number of agreements and disagreements with respect to the original sequence. A PN sequence of length N bits that contains a sufficient number of members that are orthogonal can be used. A preferred PN is a maximum length PN sequence called an “M-sequence.” This is because each phase of an M-sequence generated PN code is maximally orthogonal to each other phase. M-sequences are preferably generated by combining the outputs of feedback shift registers. Feedback shift registers comprise consecutive two-stage memory stages and feedback logic. The feedback registers are clock-driven to shift binary sequences through the shift register. If the PN generator is implemented with an M-sequence, then it is the length of the M-sequence. Orthogonal functions are required to demodulate the separate repeater transmission for multiple repeater system. The repeater 260-1 uses one member of a set of orthogonal functions. For multiple repeaters 260, the repeater 260-2 uses a different member of a set of orthogonal functions. Thus, the repeaters may be distinguished by the combination of a preferred PN sequence and unique orthogonal functions. Each repeater 260 may utilize PN codes and be identifiable by their transmitted signals.

The signals are then filtered at BPF 1026 and fed to PA 1028. At level detector 1030 the signals enter a power control loop. The power control loop clamp 1032 limits the signal to a maximum that is within the FCC limitation for transmitted power. Alternatively, the transmitter can be manually adjusted during installation, without use of a power control loop. Then, the signals are filtered by low pass filter (LPF) 1034. Finally, the signals are transmitted at transmitter 1036.

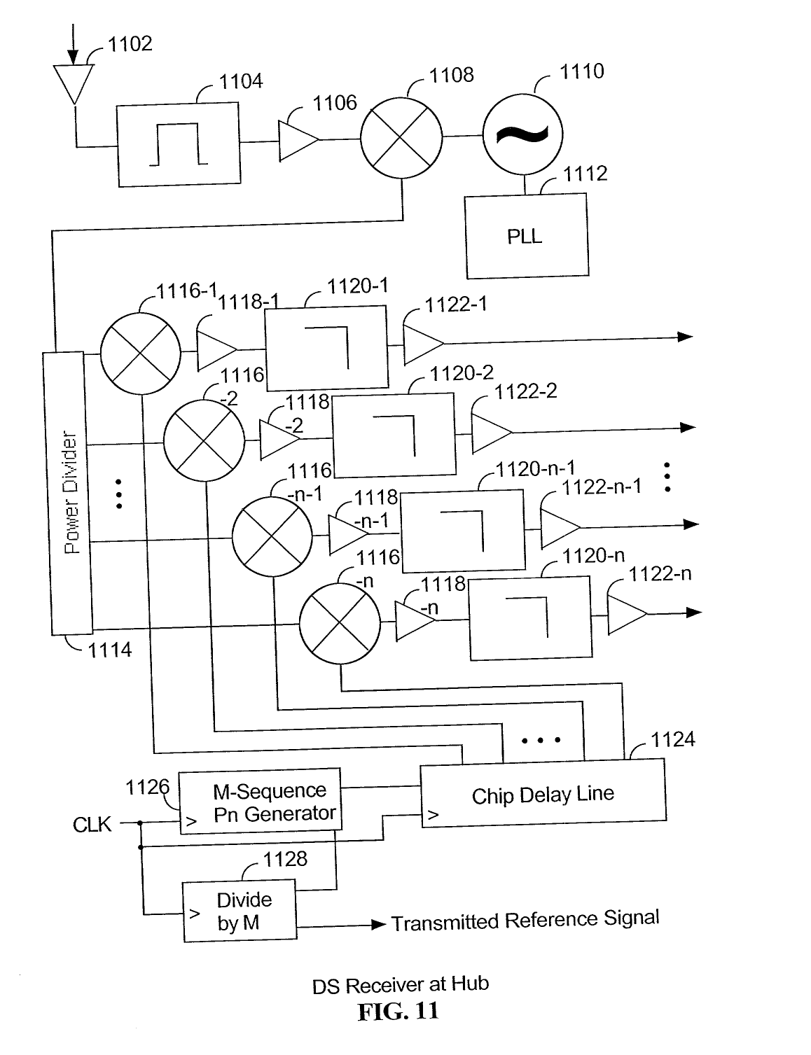

FIG. 11 illustrates a hub—also sometimes called a base station—such as a hub that would, for example, be attached to antenna 210 (FIG. 2), in accordance with an embodiment of the present invention. In FIG. 11, signals are received at receiver 1102. Received signals are filtered at BPF 1104 and amplified at LNA 1106. The PLL 1112 controls the LO 1110 in generating first LO signals. The filtered signals are mixed at mixer 608 with the first LO signals. The mixed signals are multiplexed at multiplexer (MUX) 1114 into a plurality of paths 1114_1 through 1114_N. Each path includes a mixer 1116, buffer amplifier 1118, LPF 1120, and channel output 1122. Orthogonal function selector 1124 feeds the mixers 1116 with a PN code that corresponds to the same PN code used at the repeater transmitter. The PN code received by the orthogonal function selector 1124 is from the PN generator 1126, which generates a PN code of length N bits. Each clock cycle produces a new output bit in the PN sequence, and the reset input causes the PN generator to restart at a known point in the sequence. The divide by M 1128 counts clock cycles and at the Mth clock cycle generates the output which resets the PN generator. The divide by M 1128 also produces the synchronizing reference signals which are sent via the downstream transmission to the repeaters. After the first LO signals are mixed with the corresponding PN frequency at mixer 1116, the signals are amplified at buffer amplifier 1118 and filtered at LPF 1120.

In an embodiment with multiple repeaters 260, the base station/hub 1100 performs a delay synchronization of the repeaters 260 in order to account for and remedy propagation delays associated with the distances of the repeaters 260 from the hub 1100.

The hub 1100 is able to distinguish the repeaters 260 by their orthogonal PN codes. To accomplish this, hub 1100 includes an M-Sequence PN Generator 1126 for generating PN codes. A divide by N 1128 receives the PN codes from M-sequence PN Generator 1126 and transmits reference signals for each PN code.

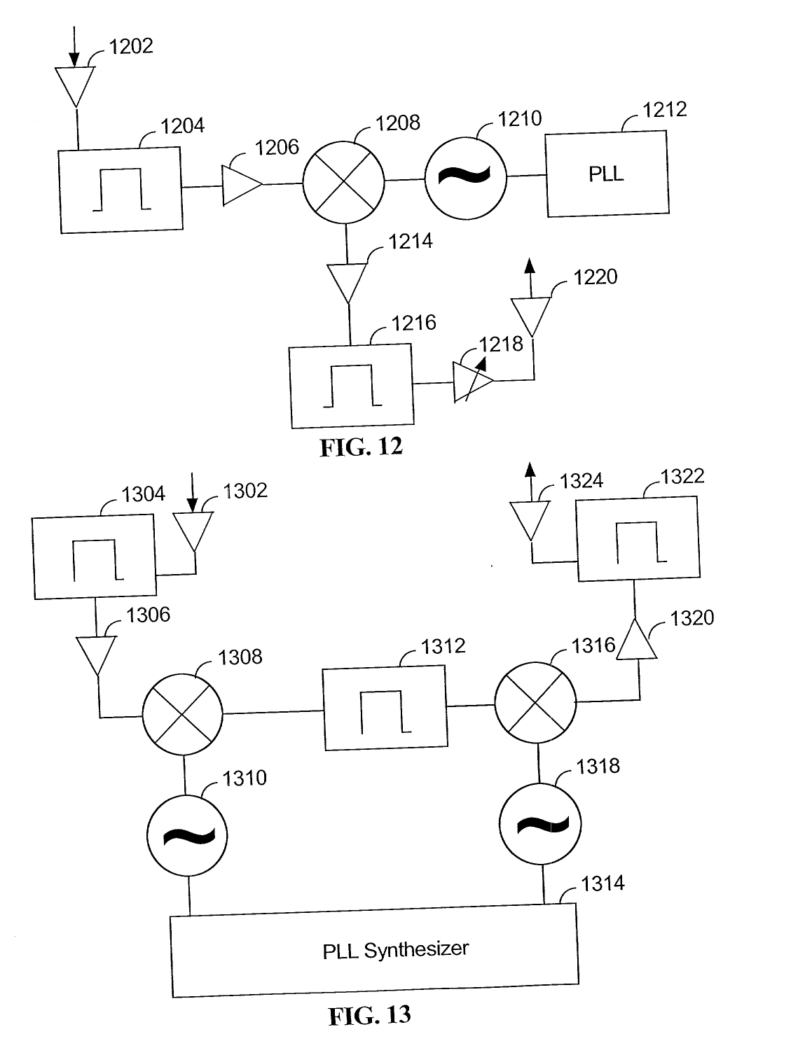

FIG. 12 illustrates a point-to-point UNII repeater in accordance with an embodiment of the invention. In FIG. 12, signals are received by receiver 1202. The received signals are filtered by band pass filter (BPF) 1204. The signals are amplified by low noise amplifier (LNA) 1206. The phase-locked loop (PLL) 1212 controls the first LO 1210 in generating first LO signals. The filtered signals are mixed at mixer 1208 with the first LO signals. The mixed signals are amplified at amplifier 1214, filtered at BPF 1216, and amplified by amplifier 1218. Finally, the signals are transmitted at transmitter 1220.

FIG. 13 illustrates a point-to-point UNII repeater in accordance with another embodiment of the present invention. In FIG. 13, signals are received by receiver 1302. The received signals are filtered by BPF 1304 and amplified by LNA 1306. The PLL synthesizer 1314 controls the first LO 1310 and the second LO 1318 in generating first LO signals and second LO signals, respectively. The filtered signals are mixed at mixer 1308 with the first LO signals. The mixed signals are filtered by intermediate frequency (IF) surface acoustic wave (SAW) BPF 1312. The IF SAW BPF 1312 preferably has an ideal (flat) band-pass response with a bandwidth that is at least equal to the bandwidth of the channel on which the signal was received by receiver 1302. The filtered signal is then mixed at mixer 1316 with the second LO signals. The mixed signals are amplified by PA and filtered by BPF 1322. Finally, the signals are transmitted at transmitter 1324.

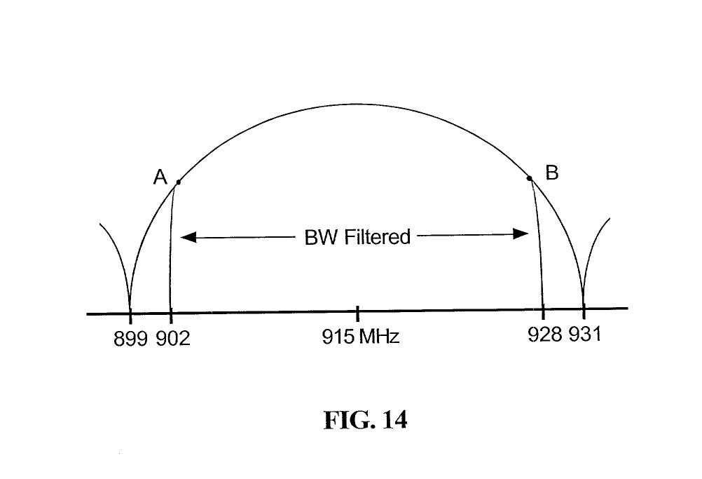

FIG. 14 illustrates the 915 MHz spectral mask used in an embodiment of the present invention. As is apparent, this invention allows transmitted signals to exactly fit into the US/N. American 902-928 MHz ISM band. This allows both license-free operation, and effective compatibility without interference to products operating at 2.4 GHz, 5.3 GHz, and 5.8 GHz.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A repeater system, comprising:
an upstream channel, comprising:
an upstream input node for receiving upstream wireless cable signals on at least a first frequency sub-band;
an upstream output node for transmitting upstream signals as spread spectrum signals, on at least a second frequency sub-band, where one of said second frequency sub-band is a non-license band;
a downstream channel, comprising:
a downstream input node for receiving downstream wireless cable signals on at least a third frequency sub-band;
a downstream output node for transmitting downstream signals on at least a fourth frequency sub-band, where one of said fourth frequency sub-band is a non-license band.

2. The system of claim 1, wherein the cable signals are DOCSIS compliant.

3. The system of claim 1, wherein said at least one first frequency sub-band has a center frequency selected from the group consisting of 2.4 GHz and 5.3 GHz.

4. The system of claim 1, wherein said at least one second frequency sub-band has a center frequency selected from the group consisting of 915 MHz, 2.4 GHz, 5.7 GHz, and 5.8 GHz.

5. The system of claim 1, wherein said at least one third frequency sub-band has a center frequency selected from the group consisting of 2.6 GHz and 2.7 GHz.

6. The system of claim 1, wherein said at least one fourth frequency sub-band has a center frequency selected from the group consisting of 5.3 GHz and 5.8 GHz.

7. The system of claim 1, wherein upstream signals are transmitted over a point-to-point 5.8 GHz UNII band system.

8. The system of claim 1, wherein said upstream signals are transmitted to an Internet service provider (ISP).

9. The system of claim 1, wherein upstream signals are transmitted onto a MMDS upstream.

10. The system of claim 1, wherein DOCSIS controls time slots as if there was no repeater.

11. A method for sending wireless cable signals, comprising the steps of:
receiving upstream wireless cable signals on a first frequency sub-band;
transmitting upstream signals as spread spectrum signals on a second frequency sub-band;
receiving downstream wireless cable signals on a third frequency sub-band;
transmitting downstream signals on a fourth frequency sub-band, where the fourth frequency sub-band is a non-license band.

12. The method of claim 11, wherein the cable signals are DOCSIS compliant.

13. The method of claim 11, wherein said at least one first frequency sub-band has a center frequency selected from the group consisting of 2.4 GHz and 5.3 GHz.

14. The method of claim 11, wherein said at least one second frequency sub-band has a center frequency selected from the group consisting of 915 MHz, 2.4 GHz, 5.7 GHz, and 5.8 GHz.

15. The method of claim 11, wherein said at least one third frequency sub-band has a center frequency selected from the group consisting of 2.6 GHz and 2.7 GHz.

16. The method of claim 11, wherein said at least one fourth frequency sub-band has a center frequency selected from the group consisting of 5.3 GHz and 5.8 GHz.

17. The method of claim 11, further comprising transmitting over a point-to-point 5.8 GHz UNII band system.

18. The method of claim 1, wherein said upstream signals are transmitted to an Internet service provider (ISP).

19. The method of claim 11, further comprising enabling DOCSIS to control time slots as if there was no repeater.

20. A repeater system, comprising:
an upstream channel, comprising:
an upstream input node for receiving upstream wireless cable signals on at least a first frequency sub-band, where said first frequency sub-band is a non-license band;
an upstream output node for transmitting upstream signals on an MMDS frequency sub-band;
a downstream channel, comprising:
a downstream input node for receiving downstream wireless cable signals on at least a third frequency sub-band;
a downstream output node for transmitting downstream signals, including the fourth signal, on at least a fourth frequency sub-band, where one of said fourth frequency sub-band is a non-license band.
